(19) United States
(12) Patent Application Publication
(10) Pub. No.: US 2009/0138402 A1
(43) Pub. Date: May 28, 2009

(54) PRESENTING PROTECTED CONTENT IN A VIRTUAL WORLD

(75) Inventors: Philip S.P. Chan, Wahroonga (AU); Kenneth Sabir, Enmore (AU)

Correspondence Address: CAREY, RODRIGUEZ, GREENBERG & PAUL, LLP, 950 PENINSULA CORPORATE CIRCLE, SUITE 3020, BOCA RATON, FL, 33487, US

(73) Assignee: INTERNATIONAL BUSINESS MACHINES CORPORATION, Armonk, NY (US)

(21) Appl. No.: 11/945,466

(22) Filed: Nov. 27, 2007

(51) Int. Cl. H04L 9/00; G06Q 10/00

(52) U.S. Cl. 705/51

(57) ABSTRACT

Embodiments of the present invention provide a method, system and computer program product for protecting content in a virtual world. In an embodiment of the invention, a method for securing confidential data in a virtual world can include generating a virtual world for different participants over a computer communications network and placing avatars for a selected set of the participants in a bounded view of the virtual world for viewing by others of the selected set of participants in the bounded view. The method further can include selecting an inanimate object containing private data in the bounded view of the virtual world. Finally, for each participant in the selected set, the method can include determining access rights for viewing the private data and displaying the private data in connection with a display of the inanimate object in the bounded view only if permitted by the access rights and otherwise obscuring the private data in connection with a display of the inanimate object in the bounded view.

### BACKGROUND OF THE INVENTION

1. Field of the Invention

The present invention relates to virtual reality and more particularly to virtual world management over a computer communications network.

2. Description of the Related Art

As the progenitor to the modern virtual world, the multi-user dungeon provided a revolutionary experience for its first participants more than three decades ago. The multi-user dungeon was and continues to be a multi-player computer game that combines elements of role-playing, first person shooter and social chat. The multi-user dungeon generally executes in a central server configured for simultaneous access by participants over a global computer communications network like the Internet. The multi-user dungeon historically has been text-driven where the immediate environment is presented to participants in text form, and participants engage in actions in the environment through textual directives mimicking the postings of an instant messenger. Non-player characters in the multi-user dungeon can be automated and the actions of the non-player characters can be broadcast to the participants also as textual postings.

Like a multi-user dungeon, virtual reality allows a user to interact with a computer-simulated environment; however in virtual reality, the virtual environment is visual in nature and can be displayed either on a computer screen or through customized or stereoscopic displays. Advanced modes of virtual reality further incorporate other sensory presentation elements, including audio elements and tactile elements. Generally, end-users interact with a virtual reality environment through traditional keyboard and mouse movements, though other input means are provided occasionally including gyroscopic handheld devices and gloves, and joysticks. Consistent throughout all virtual reality experiences, the virtual reality environment reflects the real world environment and has proven invaluable in commercial applications such as flight simulation or combat training.

The virtual world builds upon the multi-user dungeon and virtual reality in order to provide a computer-based simulated environment in which participants interact with one another through three-dimensional visually displayable surrogates referred to as avatars. In this regard, participants “inhabit” the virtual world through their respective avatars. In as much as avators can freely roam the bounds of the virtual world, virtual worlds expand the boundaries of the multi-user dungeon and permit participants to truly enjoy freedom of motion and exploration within the virtual world. To date, virtual worlds have become such close approximations to reality that the lines of reality have become blurred to the extent that many participants treat ordinary interactions in the virtual world with the same degree of seriousness as those same interactions in the real world.

In that the virtual world so closely approximates the real world, the need for privacy in the virtual world remains of paramount importance as it is in the real world. In the real world, people manage privacy by maintaining an awareness of those around. Common examples include reviewing the content of one's wallet in public, or accessing an automated teller machine (ATM) in public. In the virtual world, however, sensing the presence of others is not so easy. In the real world, one senses the presence of others not just visually, but also audibly. In fact, oftentimes, one just “feels” the presence of another. Not so in the virtual world. In the virtual world, one's avatar can sense the presence of another only through what is presented to the end user through a computer display.

### BRIEF SUMMARY OF THE INVENTION

Embodiments of the present invention address deficiencies of the art in respect to virtual world management and provide a novel and non-obvious method, system and computer program product for protecting content in a virtual world. In an embodiment of the invention, a method for securing confidential data in a virtual world can be provided. The method can include generating a virtual world for different participants over a computer communications network and placing avatars for a selected set of the participants in a bounded view of the virtual world for viewing by others of the selected set of participants in the bounded view.

The method further can include selecting an inanimate object containing private data in the bounded view of the virtual world. Finally, for each participant in the selected set, the method can include determining access rights for viewing the private data and displaying the private data in connection with a display of the inanimate object in the bounded view only if permitted by the access rights and otherwise obscuring the private data in connection with a display of the inanimate object in the bounded view. In this way, the privacy of data viewable in the virtual world can be maintained despite an inability for a participant to maintain an awareness of other participants within virtual eyeshot of the private data.

In another embodiment of the invention, a virtual world data processing system can be provided. The system can include a virtual world server configured to generate a virtual world for access by participants over a computer communications network. The system further can include a mapping of access rights for inanimate objects to participants in order to determine particular access rights for private data in connection with the inanimate objects for particular ones of the participants. Finally, the system can include privacy management logic coupled to the virtual world server and the mapping. The logic can include program code enabled to determine access rights for viewing the private data for the participants and to display the private data in connection with a display of the inanimate objects in the virtual world only if permitted by the access rights and otherwise to obscure the private data in connection with a display of the inanimate objects in the virtual world.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a pictorial illustration of a process for securing confidential data in a virtual world;

FIG. 2 is a schematic illustration of a virtual world data processing system configured for securing confidential data in a virtual world; and,

FIG. 3 is a flow chart illustrating a process for securing confidential data in a virtual world.

### DETAILED DESCRIPTION OF THE INVENTION

Embodiments of the present invention provide a method, system and computer program product for securing confidential data in a virtual world. In accordance with an embodiment of the present invention, a virtual world can be generated and configured accessible for multiple different participants, each having a respective avatar in the virtual world. Within the virtual world, inanimate objects can be provided at least one of which can include private data. Consequently, access rights for each of the participants can be consulted to determine whether or not to render the private data when rendering a corresponding one of the inanimate objects in a view to the virtual world. For those participants lacking authority to view the private data, the private data can be obscured, omitted or masked from display in the virtual world while the private data can be rendered for viewing by authorized ones of the participants.

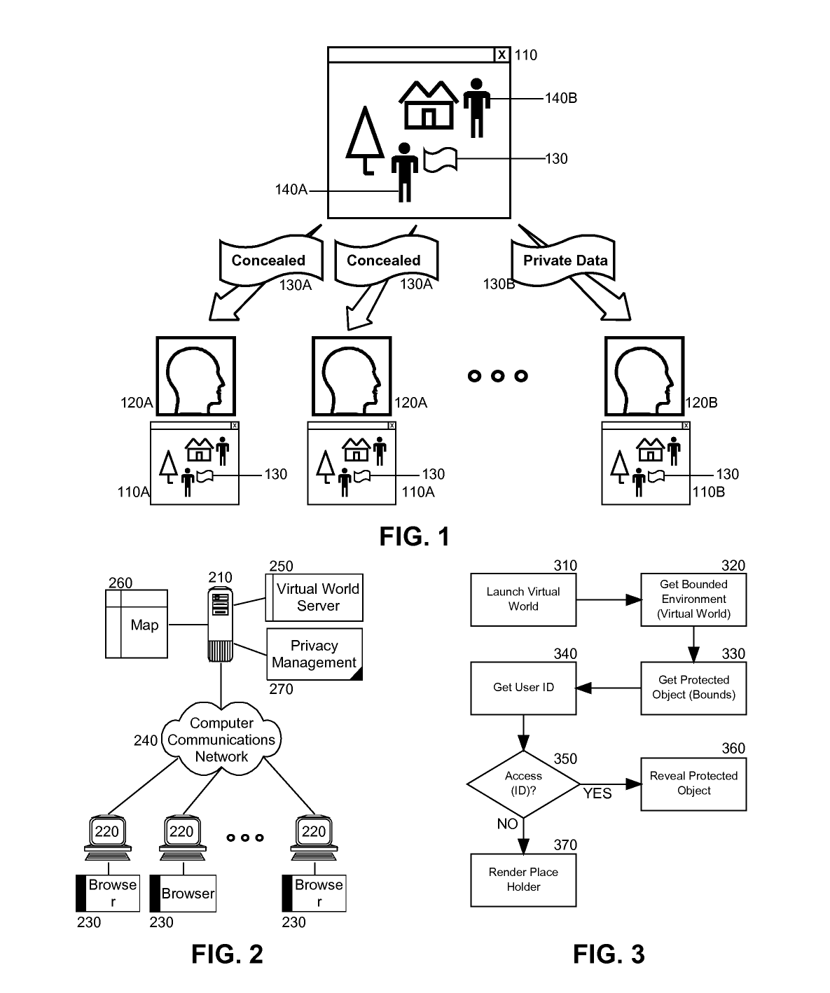

In further illustration, FIG. 1 is a pictorial illustration of a process for securing confidential data in a virtual world. As shown in FIG. 1, a virtual world 110 can be provided for interaction with one or more participants 120A, 120B. The virtual world can include an avatar 140A, 140B for each of the participants 120A, 120B, though it is to be recognized that some of the avatars 140A, 140B may be obscured from visibility at any given time according to a bounded view 110A, 110B of the virtual world 110 provided to each of the participants 120A, 120B. In this regard, though the virtual world 110 can be expansive in nature, only a discrete, bounded view 110A, 110B of the virtual world 110 can be provided at a given time to a corresponding one of the participants 120A, 120B.

Notably, one or more inanimate objects 130 (only a single inanimate object shown for the purpose of illustrative simplicity) can be rendered in the virtual world 110 for viewing by the different participants 120A, 120B through respective ones of the bounded views 110A, 110B. The inanimate object 130 can include private data and, in consequence, each of the participants 120A, 120B can be associated with access rights in an access control list. The access control list can specify that some participants 120B can be permitted to view the private data in the inanimate object 130, while other participants 120A cannot be permitted to view the private data in the inanimate object 130.

As a result, the bounded views 110A of the virtual world 110 provided to the participants 120A not permitted to view the private data will include a display of the inanimate object 130A with the private data omitted or obscured. In contrast, the bounded views 110B of the virtual world 110 provided to the participants 120B permitted to view the private data will include a display of the inanimate object 130B with the private data un-obscured and visible. In this way, privacy can be maintained within the virtual world 110 irrespective of the ability of the participants 120A, 120B to detect the presence of other participants 120A, 120B.

The process described in connection with FIG. 1 can be implemented in a virtual world data processing system. In illustration, FIG. 2 schematically illustrates a virtual world data processing system configured for securing confidential data in a virtual world. The system can include a host computing platform 210 configured for coupling to one or more computing clients 220 over computer communications network 240. The host computing platform can support the operation of a virtual world server 250 configured to creation and manage a virtual world in which different participants can participate with respective avatars through content browsers 230 coupled to corresponding ones of the computing clients 220.

Notably, privacy management logic 270 can be coupled to the virtual world server 250 through the host computing platform 210. The privacy management logic 270 further can be coupled through the host computing platform 210 to a mapping 260 of access rights to inanimate objects with private data in the virtual world by the different participants. The privacy management logic 270 can include program code enabled to direct different the virtual world server 250 to provide bounded views to an inanimate object with private in the virtual world to different ones of the participants depending upon access rights accorded to the participants in the mapping 260. In this regard, participants accorded view access to the inanimate object with private data by the mapping 260 can be provided a bounded view with a visible display of the private data in the inanimate object, while participants not accorded view access to the inanimate object with provide data by the mapping 260 can be provided with a different bounded view without a visible display of the private data in the inanimate object.

In yet further illustration of the operation of the privacy management logic 270, FIG. 3 is a flow chart illustrating a process for securing confidential data in a virtual world. Beginning in block 310 a virtual world can be launched with avatars for different participants in the virtual world. In block 320, a bounded environment can be determined for the virtual world. Specifically, a portion of the virtual world accessible to a particular one of the participants can be determined along with the avatars and inanimate objects disposed therein. In block 330, a protected object within the bounded environment of the virtual world can be identified. Likewise, in block 340, an identifier for the particular one of the participants can be determined.

In decision block 350, the identifier can be compared to an access control mapping for the protected object to determine whether or not the particular one of the participants is permitted to view private data of the protected object. If so, in block 360 the private data in the protected object can be revealed for viewing by the particular one of the participants within the bounded environment. Otherwise, in block 370 the private data of the protected can be obscured from view by the particular one of the participants within the bounded environment, for instance by masking the private data, replacing the private data with different data, or omitting the private data from a display of the protected object in the bounded environment.

Embodiments of the invention can take the form of an entirely hardware embodiment, an entirely software embodiment or an embodiment containing both hardware and software elements. In a preferred embodiment, the invention is implemented in software, which includes but is not limited to firmware, resident software, microcode, and the like. Furthermore, the invention can take the form of a computer program product accessible from a computer-usable or computer-readable medium providing program code for use by or in connection with a computer or any instruction execution system.

For the purposes of this description, a computer-usable or computer readable medium can be any apparatus that can contain, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution. Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

We claim:

1. A method for securing confidential data in a virtual world, the method comprising:
generating a virtual world for different participants over a computer communications network;
placing avatars for a selected set of the participants in a bounded view of the virtual world for viewing by others of the selected set of participants in the bounded view;
selecting an inanimate object containing private data in the bounded view of the virtual world; and,
for each participant in the selected set, determining access rights for viewing the private data and displaying the private data in connection with a display of the inanimate object in the bounded view only if permitted by the access rights and otherwise obscuring the private data in connection with a display of the inanimate object in the bounded view.

2. The method of claim 1, wherein determining access rights for viewing the private data, comprises consulting a mapping of access rights for an inanimate object to participants to determine particular access rights for the private data for a particular one of the participants.

3. The method of claim 1, wherein obscuring the private data in connection with a display of the inanimate object in the bounded view, comprises masking the private data in a display of the inanimate object.

4. The method of claim 1, wherein obscuring the private data in connection with a display of the inanimate object in the bounded view, comprises replacing the private data with other data in a display of the inanimate object.

5. The method of claim 1, wherein obscuring the private data in connection with a display of the inanimate object in the bounded view, comprises omitting the private data in a display of the inanimate object.

6. A virtual world data processing system comprising:
a virtual world server configured to generate a virtual world for access by participants over a computer communications network;
a mapping of access rights for inanimate objects to participants to determine particular access rights for private data in connection with the inanimate objects for particular ones of the participants; and,
privacy management logic coupled to the virtual world server and the mapping, the logic comprising program code enabled to determine access rights for viewing the private data for the participants and to display the private data in connection with a display of the inanimate objects in the virtual world only if permitted by the access rights and otherwise to obscure the private data in connection with a display of the inanimate objects in the virtual world.

7. A computer program product comprising a computer usable medium embodying computer usable program code for securing confidential data in a virtual world, the computer program product comprising:
computer usable program code for generating a virtual world for different participants over a computer communications network;
computer usable program code for placing avatars for a selected set of the participants in a bounded view of the virtual world for viewing by others of the selected set of participants in the virtual world;
computer usable program code for selecting an inanimate object containing private data in the bounded view of the virtual world; and,
computer usable program code for determining for each participant in the selected set access rights for viewing the private data and displaying the private data in connection with a display of the inanimate object in the bounded view only if permitted by the access rights and otherwise obscuring the private data in connection with a display of the inanimate object in the bounded view.

8. The computer program product of claim 7, wherein the computer usable program code for determining access rights for viewing the private data, comprises computer usable program code for consulting a mapping of access rights for an inanimate object to participants to determine particular access rights for the private data for a particular one of the participants.

9. The computer program product of claim 7, wherein the computer usable program code for obscuring the private data in connection with a display of the inanimate object in the bounded view, comprises computer usable program code for masking the private data in a display of the inanimate object.

10. The computer program product of claim 7, wherein the computer usable program code for obscuring the private data in connection with a display of the inanimate object in the bounded view, comprises computer usable program code for replacing the private data with other data in a display of the inanimate object.

11. The computer program product of claim 7, wherein the computer usable program code for obscuring the private data in connection with a display of the inanimate object in the bounded view, comprises computer usable program code for omitting the private data in a display of the inanimate object.
